(19) United States
(12) Patent Application Publication
(10) Pub. No.: US 2026/0140003 A1
(43) Pub. Date: May 21, 2026

(54) SENSOR MODULE, SENSOR STRIP, SENSOR ROLLER, AND METHOD

(71) Applicants: Voith Patent GmbH, heidenheim (DE); JOANNEUM RESEARCH FORSCHUNGSGESELLSCHAFT MBH, Graz (AT); FRAUNHOFER-GESELLSCHAFT ZUR FÖRDERUNG DER ANGEWANDTEN FORSCHUNG E.V., München (DE)

(72) Inventors: Stefan POLLASCHEK, Traiskirchen (AT); Anton HORAK, Wien (AT); Martin BREINEDER, Natschbach (AT); Gerhard DOMANN, Höchberg (DE); Martin ZIRKL, Wilfersdorf (AT); Andreas TSCHEPP, Kumberg (AT); Johannes ZIEGLER, Würzburg (DE); Thomas GERLACH, Dittelbrunn (DE); Stephan RUTTLOFF, Anger (AT)

(21) Appl. No.: 19/448,452

(22) Filed: Jan. 14, 2026

Related U.S. Application Data
(63) Continuation of application No. PCT/EP2024/069991, filed on Jul. 15, 2024.

(30) Foreign Application Priority Data
Jul. 18, 2023 (DE) 10 2023 118 944.1

(51) Int. Cl. G01L 5/00; B65H 5/06; G01L 1/16

(52) U.S. Cl. CPC G01L 5/0085; B65H 5/06; G01L 1/16

(57) ABSTRACT

Sensor module has one or more sensor pairs with a first sensor and a second sensor, each having an electrode for a ground terminal and an electrode for a signal terminal. The sensor module has at least one ground line as well as a first signal line and a second signal line. The first signal line is connected to the signal terminal of the first sensor, the second signal line is connected to the signal terminal of the second sensor, and the ground line is connected to the ground terminals of the first and second sensors. The sensor module extends in a longitudinal direction L from a beginning to an end, and the ground line and the signal lines run from the beginning to the end of the sensor module without crossing each other.

### CROSS-REFERENCE TO RELATED APPLICATION

This application is a continuation, under 35 U.S.C. § 120, of copending International Patent Application PCT/EP2024/069991, filed Jul. 15, 2024, which designated the United States; this application also claims the priority, under 35 U.S.C. § 119, of German Patent Application DE 10 2023 118 944.1, filed Jul. 18, 2023; the prior applications are herewith incorporated by reference in their entirety.

### FIELD AND BACKGROUND OF THE INVENTION

The invention relates to a sensor module, to a sensor strip with such sensor modules, a sensor roller with such a sensor strip, and a method for measuring a pressure profile by way of a sensor roller.

In installations for the manufacture and processing of fiber webs—hereinafter also referred to as “paper machines” for the sake of simplicity—the web usually passes through multiple treatment gaps in which the web is dewatered, coated, or smoothed, for example. These treatment gaps are also called ‘nips’. The nips are usually composed of a roller and a counter-element, in particular a counter-roller.

Such treatment gaps are also used in a variety of other fields of application, particularly where nonwovens, fabrics, films, metal sheets, or similar web-shaped materials are manufactured or processed.

For example, calenders are used in the textile industry for the finishing of textiles. Substrates are also printed using suitable transfer nips.

The fiber webs can, in particular, be paper webs, cardboard webs, or cellulose webs.

Conditions such as pressure and temperature in this nip are very important for the treatment outcome. In this context, it is not only the average value that is relevant, but particularly also the profile of these values across the width of the nip or material web. In modern facilities, the width of the nip may be up to 10 meters (33 ft) or more.

It is therefore known from the prior art to provide a number of pressure sensors that are distributed across the width of a paper web in a roller that forms the treatment gap in order to measure the pressure profile.

European Patent No. EP 23 31 923 B1 and its counterpart United States Patent No. U.S. Pat. No. 8,474,333 B2 propose the use of fiber optic sensors for this purpose. An optical waveguide with Bragg gratings is inserted into the roller covering or between the covering and the core. While these systems make accurate measurement possible, they are relatively expensive, and the effort and expense of installation is relatively high.

Piezoelectric sensors have proven to be a cost-effective and practical alternative. The use of piezoelectric sensors in sensor rollers of paper machines is already known and is described, for example, in US 2005/0261115 A1 and its counterpart EP 1 753 912 B1. There, a number of piezoelectric sensors are connected via a common ground line and a common signal line. The pressure in the nip generates an electrical signal that can be picked up via the signal line. This type of sensor roller is relatively inexpensive to manufacture, but it has some disadvantages.

As a drawback, the ceramic sensors described are comparatively thick and inflexible. During the continuous loading and unloading cycles while the sensor roll is in operation, the risk of delamination and thus destruction of the roller is relatively high.

Due to the fact that all signals run over the same signal line, special measures must also be taken to ensure a clear correlation of signal and sensor. In particular, it must be ensured that only one sensor is located in the nip at a time. Providing a separate signal line and ground line for each sensor is not only very complex, but also further increases the risk of delamination and damage, particularly when individual lines cross one another.

As an improvement to this technology, Finnish utility model FI 12489 proposes replacing the ceramic piezoelectric sensors with printed sensors. Such printed piezoelectric sensors are inherently known and described, for example, in United States Patent No. U.S. Pat. No. 9,612,690 B2 and its counterpart WO 2014/037016 A1. However, the Finnish utility model FI 12489 provides no indication to the person of skill in the art or the technological expert as to how exactly these sensors should be designed in order to be used simply and efficiently in a sensor roller.

### SUMMARY OF THE INVENTION

It is accordingly an object of the invention to provide a sensor which overcomes the above-mentioned disadvantages of the heretofore-known devices and methods of this general type and which provides for solutions and improvements to overcome the aforementioned problems of the prior art. It is a further object of the invention to propose a sensor system that is easy and inexpensive to manufacture yet can be installed in a sensor roller in a simple and risk-free manner.

With the above and other objects in view there is provided, in accordance with the invention, a sensor module comprising:
at least one sensor pair with a first sensor and a second sensor, each of said first sensor and said second sensor having a first electrode E1 (e.g., ground) and a second electrode E2 (e.g., signal);
a ground line connected to said first electrode E1 of said first sensor and to said first electrode E1 of said second sensor;
a first signal line connected to said second electrode E2 of said first sensor,
a second signal line connected to said second electrode E2 of said second sensor; and
wherein the sensor module extends in a longitudinal direction L from a beginning to an end;
said ground line, said first signal line, and said second signal line running from the beginning to the end of the sensor module without crossing one another;
each of said ground line, said first signal line, and said second signal line at the beginning of the sensor module occupying a same position in a transverse direction B of the sensor module as at the end of the sensor module; and
said first and second sensors being arranged at a same height level in the transverse direction B of the sensor module.

In other words, several objects of the invention are achieved by a sensor module which comprises at least one sensor pair with a first sensor and a second sensor, the first sensor and the second sensor each having an electrode E1—e.g., a ground terminal—and an electrode E2—e.g., a signal terminal. Furthermore, the sensor module has at least one central line, in particular a ground line, as well as a first signal line and a second signal line, the first signal line being connected to the electrode E2 of the first sensor, the second signal line being connected to the electrode E2 of the second sensor, and the central line (e.g., the ground line) being connected to the electrodes E1 of the first sensor and second sensor.

According to the invention, the sensor module extends in a longitudinal direction L from a beginning to an end, and the central line (e.g., ground line) as well as the first and second signal lines run from the beginning to the end of the sensor module without crossing each other.

Since in most common applications the central line will be embodied as a ground line, the term “ground line” will be used synonymously with the generic term “central line” in the remainder of this application unless explicitly stated otherwise. In particular, the idea described herein is not limited to the version with a ground line.

In such a sensor module, the two sensors can share a common ground line, but each has its own signal line. This means that the signals within a sensor module can always be precisely correlated with the corresponding sensor. The use of a common ground line is harmless in this respect. This reduces the effort and expense compared to a solution in which each sensor has its own ground line, which in itself is already an advantage.

However, it is not intended that the scope of this invention exclude the sensor module having additional elements, in particular additional lines. For example, a provision can be made that a second ground line is also provided, and that each sensor has its own ground line.

The sensor modules need not be limited to two sensors, however. In advantageous embodiments, the sensor module may, for example, have a number of n>1 sensor pairs, where n is preferably equal to 2, 3, or 4, and where each of the n sensor pairs has a first sensor i1 and a second sensor i2, a first and second signal line, and a ground line, and where all n*3 lines run from the beginning to the end of the sensor module without crossing each other.

Advantageously, the sensors can be arranged successively in the longitudinal direction of the sensor module.

At least one, and in particular all, of the sensors may be a pressure-sensitive sensor, particularly a piezoelectric sensor. Within this application, the invention is explained using this sensor type as an example. However, alternative or additional sensors can also be used. For example, temperature sensors can also be used. A temperature profile can also be measured without a treatment gap. The use of other sensors such as FSRs (“Force Sensing Resistors”—piezoresistive sensors) is also possible.

In principle, such a sensor module can thus be designed to be large enough to cover the entire width of the material web, e.g., of the fiber web or roller. However, this results in a significant increase in the number of lines required. Assuming a roller with a width of 10 m, and aiming for a resolution where the distance between adjacent sensors is 25 cm, a sensor module with n=20 sensor pairs would be necessary, requiring 40 signal lines and 20 ground lines. This would result in a very wide sensor module, particularly if the lines are to be prevented from crossing or running over each other.

The sensor module is therefore designed such that the ground line and the signal lines run continuously in the longitudinal direction from the beginning to the end of the sensor module. This makes it possible, in particular, to connect a number of such sensor modules in series and thereby create a sensor strip. Thus, a single sensor module can be kept relatively small—two or three sensor pairs, for example—while enabling an arbitrarily long sensor strip to be obtained by chaining multiple sensor modules together. The number of lines does not increase but rather corresponds to the number of lines of a single sensor module.

This connection can be implemented particularly easily if the sensor module has a transverse direction B and the ground lines as well as the first and second signal lines at the beginning of the sensor module each occupy the same position in the transverse direction as at the end.

In preferred embodiments, a provision can be made that the sensors and the lines are arranged on a carrier medium, in particular on a carrier film.

Designs in which the lines and sensors are printed onto the carrier medium are especially preferred.

The pressure exerted by such electrical or electronic structures is not new per se. Piezoelectric sensor elements, for example, are one obvious solution for measuring the pressure distribution in the NIP. Individual pressure measurement points on non-planar surfaces are described, for example, in U.S. Pat. No. 8,479,585 B2. This describes the use of piezoelectric copolymers as individual sensors and as a matrix.

If it is wished to use piezoelectric polymers based on PVDF, one can either use pre-stretched films made of the pure polymer or a copolymer whose ferroelectric phase (β-phase)—in particular its ferroelectrically active stereochemical chain structure—establishes itself automatically, such as in the case of P(VDF-TrFE), for instance. Due to the self-orienting properties of the polymers, the material can also be printed, for example by screen printing, inkjet printing, etc. One pressure formulation that has proven advantageous is described, for example, in US 2013/0153814 A1 and EP 2609142 B1. In principle, however, other printing methods such as gravure printing, flexographic printing, or offset printing can also be used.

Numerous other publications, such as US 2021/0408364 A1 and its counterpart WO 20074075 A1 or Patent No. U.S. Pat. No. 9,612,690, B2 and its counterpart WO 2014/037016 A1, exist which relate to the printing of piezoelectric polymers and the generation of piezoelectric sensors.

The proposed construction of a long sensor strip made of many short sensor modules as described in the invention proves very helpful, since printing can be done ‘from roller to roller’ using one or more printing rollers. A (roller) screen printing process can be advantageously used for this purpose.

The size of the motif is limited by the circumference of the printing roller, however. Typically, such printing rollers have a circumference between 30 cm and 2 m. However, the sensor rollers in which such sensor strips are to be used are often significantly wider than 2 m. For instance, textile calenders with a width of 7 m are not uncommon. Paper machine rollers very often have widths of 10 m (33 ft) and more. In order to print a sensor strip 10 m long in this way, one would have to use a printing cylinder with a diameter of more than three meters. That is not feasible.

Within the scope of this invention, it is now possible to match the length of the sensor module to the circumference of the existing pressure cylinder, so that, for example, the length of the sensor module corresponds exactly to the circumference of the pressure cylinder.

If the ground lines and the first and second signal lines at the beginning of the sensor module each occupy the same position in the transverse direction as at the end, the printed image is repeated iteratively for each screen printing roll circumference. The leads to the individual sensors are connected to each other upon each rotation of the printed image, so that very long (e.g., 150 m) sensor strips with continuous contact leads can be created which are capable of contacting a defined number of printing elements per rotation, if necessary. These very long printed images are made possible by precisely registering and aligning the screen with the already printed structures in each revolution, so that the offset remains below a certain tolerance both across and along the roll.

Because the number of lines is not arbitrarily large, but rather corresponds to the number of lines of a single sensor module, the sensor strip remains very narrow. This is advantageous because it means that most commercially available printing rollers can be used, which can have a width of 60 cm, for example.

The lines can, in particular, have a width between 1 mm and 3 mm, preferably between 1.5 mm and 2.6 mm. The spacing distance, or width, between the lines may, in particular, be between 0.5 mm and 3 mm, preferably between 1 mm and 2.6 mm.

The sensor size is scalable and can also deviate from the round shape if required.

The elements of the sensor module are typically printed in multiple layers. A sensor module according to aspects of the invention can be composed of 5 layers, for example:

| | |
|---|---|
| 1st layer: | conductor paths |
| 2nd layer: | electrode E1 (e.g., ground) |
| 3rd layer: | sensor layer 1 |
| 4th layer: | sensor layer 2 |
| 5th layer: | electrode E2 (e.g., signal) |

If the sensor module is to be embodied as a piezoelectric sensor, the sensor layers 3 and/or 4 can be used. The layer contains piezoelectric polymers. The 3rd and/or 4th layer can also have an insulating effect, particularly in piezoelectric sensors, in order to isolate the electrodes E1 and E2 from each other. When using piezoresistive sensors (FRS sensors), however, the layers 3 and 4 are usually not insulating.

Furthermore, additional layers may also be provided. The sensor module can, in particular, additionally include a 6th protective layer.

This final protective layer can protect the electrodes and conductor paths both during handling (e.g., installation in a roller) and during operation of the sensor module.

Additional layers may also be provided depending on the application, such as adhesive layers for attaching to a substrate.

The functional layers described above can each be produced in a single printing operation. Alternatively, a provision can also be made that one or more of these functional layers are produced by repeated overprinting and thus have a layered structure within themselves.

How a suitable routing of lines can be implemented according to aspects of the invention will be explained later with reference to the figures.

To avoid crossing lines, it can be advantageous if the lines are arranged such that, for each sensor pair, the respective ground line runs in the transverse direction between the associated first signal line and the second signal line from the beginning to the end of the sensor module.

The sensor pair can then be positioned such that the first sensor is located between the first signal line and the ground line, while the second sensor is located between the ground line and the second signal line. There is thus no crossing of the three lines themselves, even upon connection of the sensors to the lines.

In the sensor modules and sensor strips according to various aspects of the invention, sensor pairs and the arrangement thereof are a central element. Typically, the sensor modules or sensor strips will be made up of a certain number of sensor pairs and will thus have an even number of sensors. These are usually the most advantageous designs, but this is not absolutely necessary.

For example, a sensor module that has a certain number of sensor pairs may also comprise one or more additional, individual sensors.

A sensor strip that comprises multiple sensor modules can also have additional, individual sensors.

The figures show examples of variations for such sensor modules or sensor strips.

According to another aspect of the invention, a sensor strip for use in a roller in a machine for manufacturing or processing a web of material is proposed in which the sensor strip comprises at least two, in particular five or more, sensor modules according to an aspect of the invention, the sensor modules being arranged successively in the longitudinal direction L on a common carrier medium, in particular a common carrier film.

Preferably, the sensor modules are of the same type, and the ground lines and signal lines at the end of the preceding sensor module are connected to the corresponding lines at the beginning of the subsequent module.

To produce such a sensor strip, a very long master roller can be printed with repeating sensor modules (e.g., 100 m long or more). The required length can then be cut off from this as needed in the form of a sensor strip. This enables the printing of the sensor system to be completely separated from the application. This results in cost advantages and a reduction in production time, since the sensor strip is available immediately upon receipt of the order, and there is no need to wait for the printing process.

The width of the sensor strips can vary from application to application, but is usually less than 60 cm, particularly less than 40 cm.

Finally, a sensor roller is proposed for a machine for the manufacture or processing of a material web, for example a fiber web, a textile web, a plastic web, or a metal web. The roller comprises a roller core and a roller jacket made of a polymer material. The roller also comprises at least one sensor strip according to an aspect of the invention.

The sensor strip can be positioned in various locations. For example, the sensor strip can be positioned between the core and the jacket. Alternatively, it can be embedded in the polymer material of the jacket.

Finally, it is also possible to arrange the sensor strip on the roller surface. The latter is advantageous particularly for maintenance work, as the sensor strip can be used as a mobile measuring system to correctly adjust the profile of a treatment gap. The sensor strip can then be removed. This means that rollers can also be measured even if a sensor strip was not already provided during manufacturing.

Since each signal line is usually connected to one sensor per sensor module, care must be taken when arranging the sensor strip to ensure that only one connected sensor per signal line passes through the treatment gap at any given time in order to reliably correlate the signals with the corresponding sensors. This can be achieved, for example, by arranging the sensor strip helically in or on the sensor roller. The angle of the helix can be chosen so as to be relatively shallow. It is not a problem if multiple sensors pass through the treatment gap simultaneously, as long as they are connected to different signal lines.

In advantageous embodiments, a provision can be made that an evaluation unit is associated with the sensor roller which is designed to receive and evaluate the signals from the sensors.

The evaluation unit can be attached directly to the roller, for example to a cover on the end face. Alternatively, a provision can also be made that only one data unit is attached to the roller which transmits the captured signals to the actual evaluation unit. In particular, the transmission can occur wirelessly.

The transmission of data or signals to the evaluation unit can be continuous. Alternatively, the transmission can also take place only at discrete times, particularly upon explicit request. That way, the sensor system can be designed to be more energy-efficient.

The evaluation unit can, in particular, determine and/or display a profile, particularly a pressure profile, from the received signals across the width of the material web or treatment gap.

One object here is for the evaluation unit to be able to determine from which of the sensors a signal on a signal line originated. One of the methods that are known from the prior art can be used for this purpose. For example, the roller may have a separate sensor that determines the current rotational position of the roller (e.g., Hall sensor, accelerometer, etc.).

Alternatively, or in addition, the correlation can also be established through the type of placement of the sensor strip. If the sensor strip is applied in a uniform helix, the angular distance between two adjacent sensors on a signal line is always the same. The helix can now be applied in such a way that it runs significantly less than 360° around the roller. This results in the angular distance between the last sensor and the first sensor being greater than the other distances. Thus, the evaluation unit can very easily determine which signal originates from the first sensor of the strip. Correlating the remaining sensors is then simple. For such a design, it is very advantageous that the sensor strips can be laid in a very flat helix according to aspects of the invention. This ensures that the sensor strip runs significantly less than 360° around the roller even in the case of long rollers.

Furthermore, a provision can be made that the sensor roller forms a second treatment gap with a second counter-element. If the helix is arranged so as to be sufficiently flat, it is possible to measure both treatment gaps with the same sensor strip.

In advantageous embodiments, a provision can also be made that two sensor strips are attached to one sensor roller. For example, one can be connected while the other serves as a backup. This enables the reliability of the system to be increased without incurring significant additional costs.

Finally, a method for measuring a pressure profile in a treatment gap in a method for processing fiber webs, nonwovens, fabrics, films, metal webs or other material webs is also proposed in which the treatment gap is composed of a sensor roller and a counter-element, in particular a counter-roller. A provision is made that the sensor roller is designed according to an aspect of the invention, and that each sensor generates a signal when passing through the treatment gap which corresponds to the pressure in the treatment gap.

The fiber webs can, in particular, be paper webs, cardboard webs, or cellulose webs.

The method for processing nonwovens, fabrics, films, metal sheets, or other web-shaped materials is preferably selected from the group consisting of:
Coating processes
encapsulations, particularly in photovoltaics
packaging technology, particularly food packaging
battery manufacturing, particularly in the manufacture of anodes, cathodes, and separators
OLED and optical layers
anti-scratch coating, anti-dust coating, electrostatic coatings
Bonding processes, laminating processes, calendering processes
Laminations
encapsulation
multi-composite
PCB laminates
packaging or pouches
battery and fuel cell manufacturing
wound capacitors
flexible electronic circuits and solar cells, displays
medical applications, particularly bandage manufacturing, test strips
Mounting processes
   electronic components
Grinding mills
Conveyor belts
   recycling
   sorting
Extrusion installations
   Film manufacturing
Printing processes
   graphic printing
   newspaper and paper printing, labels
   money printing
   printed electronics
   offset printing, gravure printing, flexographic printing, engraving printing, OLED and optical applications
Imprinting processes
   nanoimprint lithography
   hot-stamping, particularly of anti-reflective coatings
Path optimization
   measurement of web tension
   measurement of tensile force
   vacuum coating, particularly metal coatings, including for food
Finishing of textiles, in particular by printing, coating, or dyeing,
Steel and metal strip manufacturing
Condition monitoring for large substrates, particularly wind turbines

As a further possible application for the sensor strips according to the invention, an application is also proposed in which the sensor strip is installed on a fixed surface in order to detect collisions over a large area in a specific region. The speed and start time of the moving collision object (=test specimen)—or the velocity vector component parallel to the sensor surface—can be used to determine the location of the collision. This can be used to advantage in precipitation columns, for example.

Compared to a sensor strip that is known from the prior art, in which all sensors are connected to the same signal line and the same ground line, a sensor strip according to aspects of the invention enables a more precise determination of the collision point. This is made possible by enabling the position of the sensor that generated the signal within a sensor module to be precisely determined. In the case of large test objects, for example, it is possible to determine more precisely which part of the test object triggered the collision.

Alternatively, or in addition, it is also possible to correct inaccuracies in location determination using sensor strips according to the invention. Such inaccuracies can arise, for example, from deviations from the ideal trajectory due to friction or impact impulses-particularly if multiple collisions occur during the movement. Thus, a sensor strip according to the invention can not only determine the point of collision but also correct errors in the location determination.

The listed applications are intended to illustrate the possible uses of the invention. It will be understood, however, that the invention is not limited to these applications.

Although the invention is illustrated and described herein as embodied in a sensor module, a sensor strip, a sensor roller, and a method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a sensor module according to one aspect of the invention.

FIG. 2A shows a sensor module according to another aspect of the invention.

FIG. 2B shows a sensor module according to another aspect of the invention.

FIG. 2C shows a sensor module according to another aspect of the invention.

FIG. 3 shows a sensor strip according to another aspect of the invention.

FIG. 4 shows a device for carrying out a method according to another aspect of the invention.

### DETAILED DESCRIPTION OF THE INVENTION

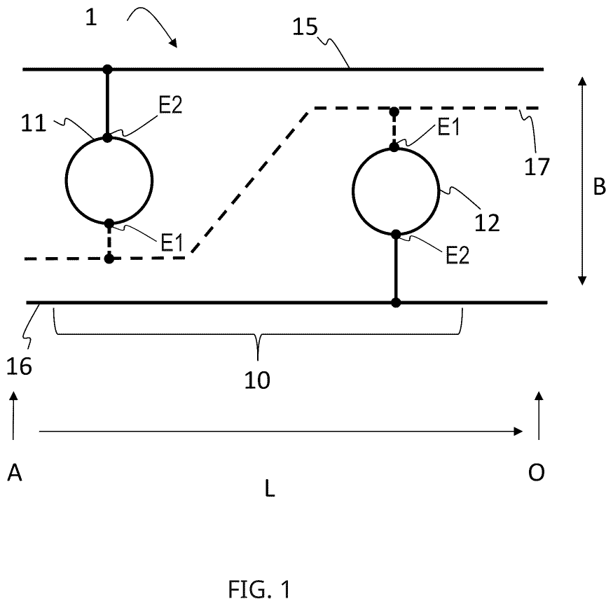

Referring now to the figures of the drawing in detail and first, in particular, to FIG. 1 thereof, there is shown a simple embodiment of a sensor module 1 according to the invention. The sensor module 1 has exactly one sensor pair 10 consisting of a first sensor 11 and a second sensor 12. These are arranged successively when viewed in the longitudinal direction L. Furthermore, the sensor module 1 has a first signal line 15 and a second signal line 16 as well as a ground line 17.

The first sensor 11 is connected to the first signal line 15 and the ground line 17, whereas the second sensor 12 is connected to the second signal line 16 and the ground line 17.

The three lines 15, 16, 17 run substantially in a longitudinal direction L and run from the beginning A to the end O of the sensor module 1. To prevent the lines 15, 16, 17 from crossing each other, the signal lines 15, 16 run on the outside when viewed in a transverse direction B, and the two sensors 11, 12, of the sensor pair 10 are arranged between the signal lines 15, 16.

The ground line 17 also runs between the signal lines 15 and 16. In the drawing, the ground 17 runs below the first sensor 11 and then above the second sensor 12.

The sensors 11, 12 are arranged such that, in the first sensor 11, the electrode E2 is directed upward and the electrode E1 downward, while in the second sensor 12, the electrode E1 is conversely directed upward and the electrode E2 downward.

As can be seen in FIG. 1, this arrangement is advantageous because neither the actual signal lines 15, 16, 17 nor the connections of the sensors 11, 12 cross over the entire sensor module 1.

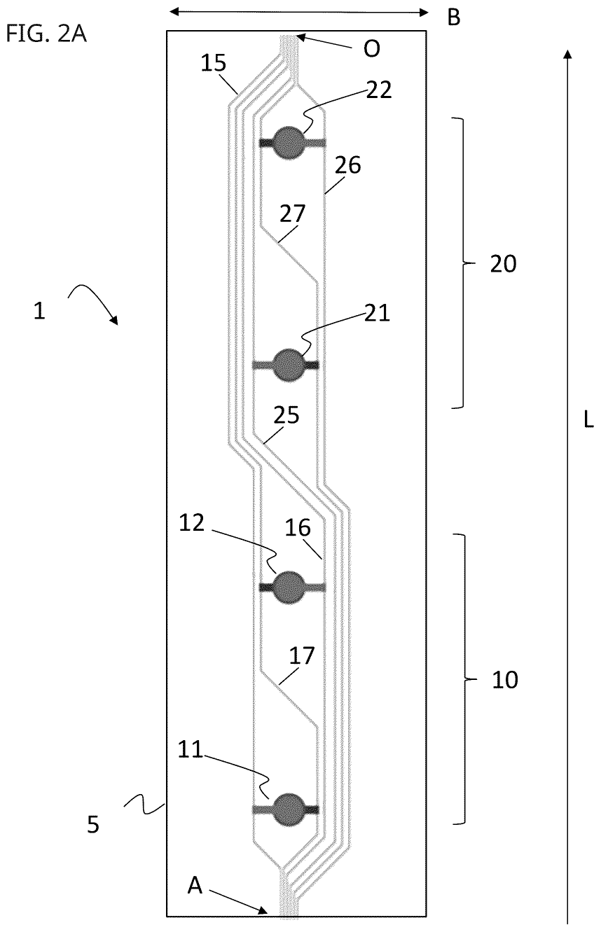

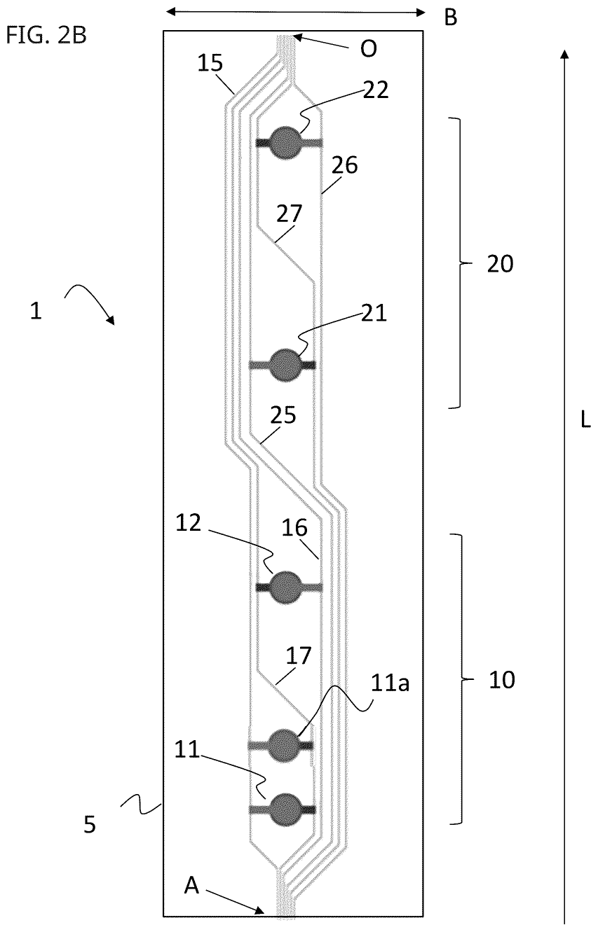

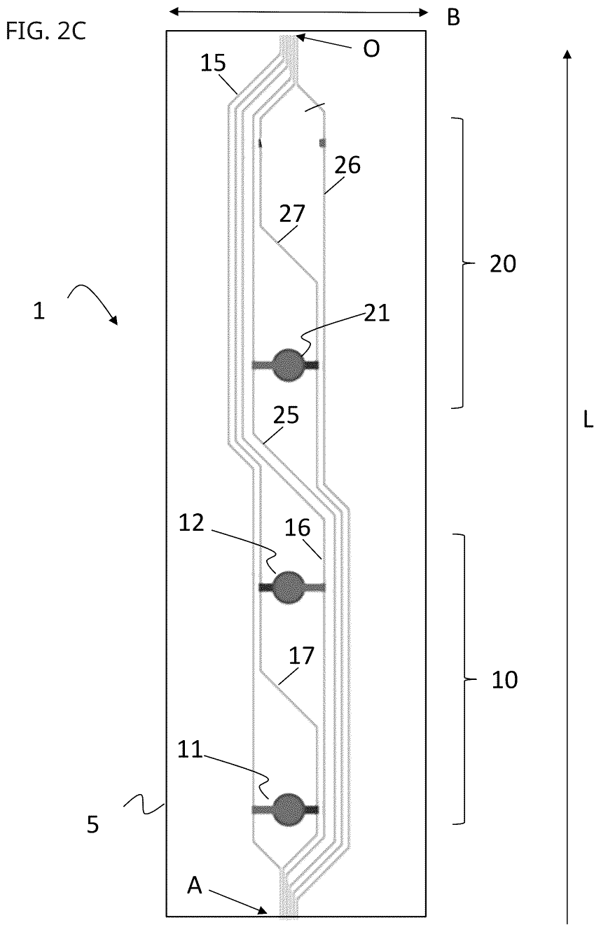

FIG. 2A shows a sensor module 1 that is made up of two sensor pairs 10, 20. In terms of the systematic arrangement of the signal lines 15, 16, 25, 26 and of the ground lines 17, 27, this sensor module 1 is comparable to a doubling of the sensor module 1 from FIG. 1. After the second sensor 12, the three lines 15, 16, 17 are routed to the end O of the sensor module 1 above the first signal line 25 of the second sensor pair 20, while the lines 25, 26, 27 of the second sensor pair 20 are routed from the beginning A of the module 1 to the second sensor pair 20 below the second signal line 16 of the first sensor pair 10.

Those skilled in the art will recognize that sensor modules 1 with additional sensor pairs 1 in which the lines do not cross despite the ever-increasing number can also be implemented in this way. However, such sensor modules 1 become steadily wider due to the increasing number of lines.

In the sensor module 1, the four sensors 11, 12, 21, 22 are arranged successively in the longitudinal direction L of the sensor module 1. In the transverse direction B of sensor module 1, they are arranged at the same height. To avoid crossings, the lines 15, 16, 17, 25, 26, 27 are arranged such that, for each sensor pair 10, 20 from the beginning A to the end O of the sensor module 1, the ground line 17 runs in the transverse direction B between the first signal line 15 and the second signal line 16, and the ground line 27 runs in the transverse direction B between the first signal line 25 and the second signal line 26.

All ground lines 17, 27 and signal lines 15, 16, 25, 26 are routed such that they occupy the same position in the transverse direction B at the beginning A of the sensor module 1 as at the end O. This makes it easier for multiple sensor modules 1 to be connected together to form a sensor strip 2.

Both the sensors 11, 12, 21, 22 and the lines 15, 16, 17, 25, 26, 27 are arranged on a carrier medium 5, usually a carrier film 5.

Such sensor modules 1 can be manufactured very efficiently using printing processes, for example in a roller screen printing process.

The sensor module 1 of FIG. 2B is one possible embodiment in which the sensor module 1 is not exclusively composed of sensor pairs 10, 20, but also comprises an additional sensor.

The sensor module 1 in FIG. 2B largely corresponds to the sensor module in FIG. 2A and comprises two sensor pairs 10, 20. The only difference is that an additional sensor 11a is provided in the sensor module 1. In this case, the additional sensor 11a is identical to the first sensor 11 of the first sensor pair 10, is arranged analogously thereto, and is also connected to the ground line 17 and the first signal line 15. It is readily apparent that multiple additional sensors 11a can also be provided at other locations in this way. Such additional sensors 11a can be advantageous, for example, for obtaining a redundant system that continues to receive measured values even if the first sensor 11 fails.

FIG. 2C also shows another embodiment in which the sensor module 1 is not composed exclusively of sensor pairs 10, 20. In comparison to the sensor module 1 of FIG. 2A, the second sensor 22 of the second sensor pair 20 is omitted in FIG. 2C as an example.

FIGS. 2A, 2B, and 2C illustrate the diverse ways in which sensor modules can be structured according to aspects of the invention. The invention is not limited to the alternatives presented here.

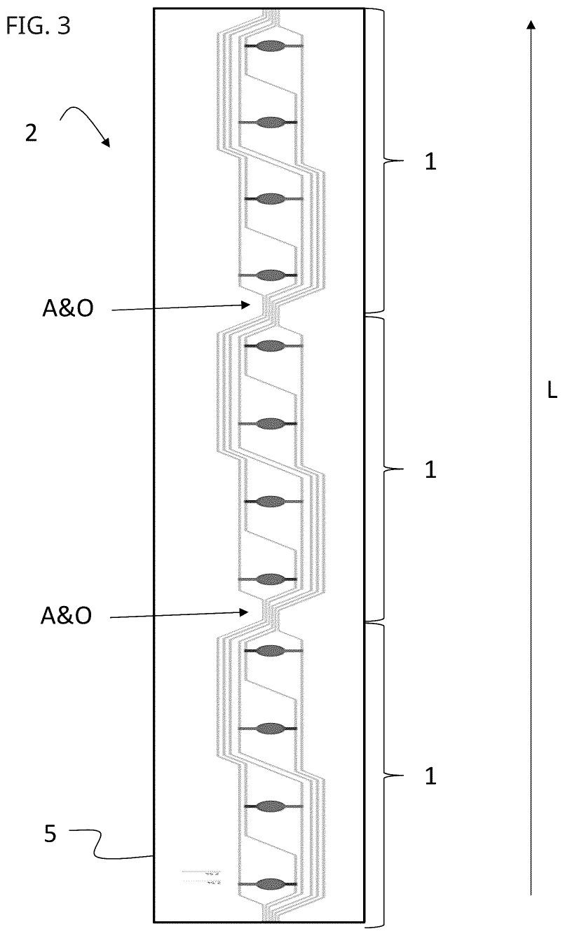

FIG. 3 shows a sensor strip 2 consisting of multiple (here: three) sensor modules 1 like those in FIG. 2A. These sensor modules 1 were printed onto a common carrier medium 5. The design of the sensor modules 1 can be adapted to the pressure roller in such a way that a whole number of sensor modules 1 fit on the pressure roller. Sensor strips of almost any length can be printed onto a roller in advance. For a specific application, a sensor strip 2 of the required length can then be cut from the roller and processed.

The lines 15, 16, 17, 25, 26, 27 can, in particular, have a width between 1 mm and 3 mm, preferably between 1.5 mm and 2.6 mm. The distances between the lines 15, 16, 17, 25, 26, 27 can, in particular, have a width between 0.5 mm and 3 mm, preferably between 1 mm and 2.6 mm.

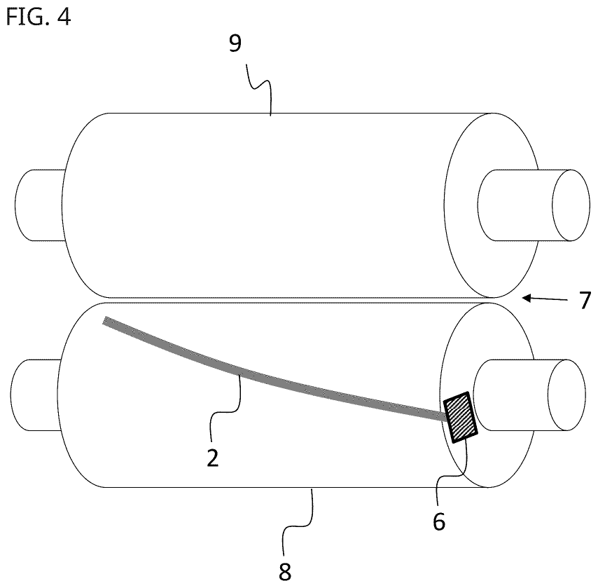

FIG. 4 shows a device for carrying out a method according to another aspect of the invention. The device can be a calender or a coating assembly, for example. The device has a treatment gap (“nip”) 7 that is formed by a sensor roller 8 and a counter-element 9 in the form of a counter-roller 9. The rollers 8 and 9 roll in opposite rotational directions during operation.

A sensor strip 2 is provided according to an aspect of the invention at least in the sensor roller 8. The sensor strip can, for example, be arranged in or under the polymer jacket of the sensor roller 1. An arrangement on the roller surface (usually temporary) is also conceivable.

The sensor strip 2 extends over the entire width of the nip 7, more particularly over the entire width of the material web to be treated—for instance, a fiber web or fibrous web. Since the sensor strip 2 is arranged helically, the length of the sensor strip 2 can be greater than the width of the roller 8.

As can be seen in FIG. 4, the helix can be very flat, and in particular it can describe significantly less than one turn around the sensor roller 8. The helical arrangement is essentially intended to ensure that no two sensors 11, 12, 21, 22 which use the same signal line 15, 16, 25, 26 are ever located simultaneously in the nip 7. This can be achieved with a very shallow winding of the sensor strip 2.

The longer the sensor modules 1 are, the flatter the winding can be. For example, if the sensor module from FIG. 1 is used, it must be ensured that, with a sensor 11, 12, only the directly adjacent sensor 11, 12 is also in the nip 7, since the following sensor is already using the same signal line 15, 16 again.

In the sensor module 1 from FIG. 2A, four sensors 11, 12, 21, 22 can already be in the nip 7 simultaneously without any problems occurring. Therefore, a shallower winding can be used.

In the extreme case—which is usually not technically advantageous—that the entire sensor strip 2 is made up of only a single sensor module 1, each sensor would have its own signal line. In this case, spiraling can be completely dispensed with.

The beginning A of the sensor strip 2 is located at a front end of the sensor roller 8. There, the lines 15, 16, 17, 25, 26, 27 can be connected to a data unit 6, which transmits the captured signals to an evaluation unit. The best way to transmit the data is wirelessly. Advantageously, a power supply is also provided in the data unit 6 in order to ensure data transmission, for example. The evaluation unit 6 is designed to receive and evaluate the signals from the sensors. It can also be advantageous when the data unit 6 is simultaneously embodied as an evaluation unit 6, so that at least parts of the data evaluation can be carried out directly on the roller.

The following is a summary list of reference numerals and the corresponding structure used in the above description of the invention:
1 sensor module
2 sensor strip
5 carrier film
6 data unit/evaluation unit
7 treatment gap/“nip”
8 sensor roller
9 counter-roller
10 first sensor pair
11 first sensor of the first sensor pair
11a additional sensor in the sensor module
12 second sensor of the first sensor pair
15 first signal line
16 second signal line
17 central line; ground line
20 second sensor pair
21 first sensor of the second sensor pair
22 second sensor of the second sensor pair
25 first signal line
26 second signal line
27 ground line
L longitudinal direction
B transverse direction
A beginning
O end
E1 electrode (ground)
E2 electrode (signal)

1. A sensor module comprising:
at least one sensor pair with a first sensor and a second sensor, each of said first sensor and said second sensor having a first electrode E1 and a second electrode E2;
a ground line connected to said first electrode E1 of said first sensor and to said first electrode E1 of said second sensor;
a first signal line connected to said second electrode E2 of said first sensor,
a second signal line connected to said second electrode E2 of said second sensor; and
wherein the sensor module extends in a longitudinal direction L from a beginning to an end;
said ground line, said first signal line, and said second signal line running from the beginning to the end of the sensor module without crossing one another;
each of said ground line, said first signal line, and said second signal line at the beginning of the sensor module occupying a same position in a transverse direction B of the sensor module as at the end of the sensor module; and
said first and second sensors being arranged at a same height level in the transverse direction B of the sensor module.

2. The sensor module according to claim 1, wherein:
said at least one sensor pair has a number of n>1 sensor pairs, with n being an integer;
each of said n sensor pairs has a first sensor and a second sensor, a first signal line, second signal line, and a ground line, and wherein all n*3 lines run from the beginning to the end of the sensor module without crossing one another.

3. The sensor module according to claim 2, further comprising an additional sensor.

4. The sensor module according to claim 2, wherein each of said ground lines, said first signal lines, and said second signal lines at the beginning of the sensor module assumes the same position in the transverse direction B as at the end.

5. The sensor module according to claim 1, which comprises a carrier medium, and wherein said sensors, said ground line, and said signal lines are arranged on said carrier medium.

6. The sensor module according to claim 5, wherein said sensors and said lines are printed onto said carrier medium by screen printing or by inkjet printing.

7. The sensor module according to claim 1, wherein:
for each sensor pair from the beginning to the end of the sensor module, said ground line runs in the transverse direction B between said first signal line and said second signal line; and
for at least one said sensor pair, said first sensor is arranged between said first signal line and said ground line, while said second sensor is arranged between said ground line and said second signal line; and
neither of the ground and signal lines (15, 16, 17; 25, 26, 27) themselves cross one another, nor does a connection of said first and second sensors to the lines (15, 16, 17; 25, 26, 27).

8. The sensor module according to claim 1, wherein the lines (15, 16, 17; 25, 26, 27) have a width between 1 mm and 3 mm, and spacing distances between the lines (15, 16, 17; 25, 26, 27) have a width between 0.5 mm and 3 mm.

9. The sensor module according to claim 1, wherein the lines (15, 16, 17; 25, 26, 27) have a width between 1.5 mm and 2.6 mm and the spacing distances between the lines (15, 16, 17; 25, 26, 27) lie between 1 mm and 2.6 mm.

10. The sensor module according to claim 1, wherein at least one of said first and second sensors, or all of said first and second sensors, are pressure-sensitive sensors.

11. The sensor module according to claim 10, wherein said first and second sensors piezoelectric sensor.

12. A sensor strip configured for a roller in a machine for manufacturing or processing a material web, the sensor strip comprising:
a plurality of at least two sensor modules according to claim 1 arranged successively in the longitudinal direction L on a common carrier medium.

13. The sensor strip according to claim 12, wherein said common carrier medium is a carrier film.

14. The sensor strip according to claim 12, wherein said sensor modules are sensor modules of a same type, and the ground lines and signal lines at the end of a preceding sensor module are connected to corresponding lines at the beginning of a subsequent module.

15. A sensor roller for a machine for manufacturing or processing a material web, the sensor roller comprising:
a roller core and a roller jacket made of a polymer material; and
at least one sensor strip having a plurality of at least two sensor modules according to claim 1 arranged successively in the longitudinal direction L carried on said roller jacket.

16. The sensor roller according to claim 15, wherein said sensor strip is arranged helically in or on said sensor roller.

17. The sensor roller according to claim 15, comprising an evaluation unit configured to receive and evaluate signals received from said sensors via said first and second signal lines.

18. A method for measuring a pressure profile in a treatment gap that is configured for processing material webs, fiber webs, nonwovens, fabrics, films, or metal webs, the treatment gap being formed by a sensor roller and a counter-element, the method comprising:
providing a sensor roller with a roller core, a roller jacket made of a polymer material supported on the roller core, and at least one sensor strip having at least two sensor modules according to claim 1 arranged successively in a longitudinal direction L carried on the roller jacket; and
generating by each sensor a signal when passing through the treatment gap which corresponds to a pressure in the treatment gap.

19. The method according to claim 15, which comprises measuring the pressure profile while performing a process selected from the group consisting of:
coating processes
encapsulations, particularly in photovoltaics
packaging technology, particularly food packaging
battery manufacturing, particularly in the manufacture of anodes, cathodes, and separators
OLED and optical layers
anti-scratch coating, anti-dust coating, electrostatic coatings
bonding processes, laminating processes, calendering processes
laminations
encapsulation
multi-composite
PCB laminates
packaging or pouches
battery and fuel cell manufacturing
wound capacitors
flexible electronic circuits and solar cells, displays
medical applications, particularly the manufacture of bandages or test strips
mounting processes
electronic components
grinding mills
conveyor belts
recycling
sorting
extrusion installations
film manufacturing
printing processes
graphic printing
newspaper and paper printing, labels
money printing
printed electronics
offset printing, gravure printing, flexographic printing, engraving printing, OLED and optical applications
imprinting process
nanoimprint lithography
hot-stamping, particularly of anti-reflective coatings
path optimization
measurement of web tension
measurement of tensile force
vacuum coating, particularly metal coatings, including for food
finishing of textiles, in particular by printing, coating, or dyeing,
steel and metal strip manufacturing
condition monitoring for large substrates, particularly wind turbines.

20. A method for determining a collision point of a moving test specimen with a fixed surface, wherein the test specimen moves parallel to the fixed surface, and the method which comprises:
providing the fixed surface with a sensor strip having a plurality of at least two sensor modules according to claim 1 arranged successively in a longitudinal direction L on a common carrier medium on the fixed surface; and
determining the collision point by a sensor signal generated by a sensor of the sensor modules and, optionally, using a start time and a speed of the test specimen.
